(19) United States
(12) Patent Application Publication
(10) Pub. No.: US 2010/0271938 A1
(43) Pub. Date: Oct. 28, 2010

(54) TRANSMISSION APPARATUS, METHOD FOR TRANSMISSION, AND TRANSMISSION SYSTEM

(75) Inventor: Ryoichi MUTOH, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/726,676

(22) Filed: Mar. 18, 2010

(30) Foreign Application Priority Data
Apr. 22, 2009 (JP) 2009-103806

(51) Int. Cl. G06F 11/00

(52) U.S. Cl. 370/228

(57) ABSTRACT

Transmitting a frame through a working path and a protection path is accomplished by detecting a failure occurring on the working path; changing a first destination address in the frame to a second destination address in accordance with the result of the detecting; and transmitting the frame after the changing to the protection path.

### CROSS-REFERENCE TO RELATED APPLICATION

This application is based upon and claims the benefit of priority of the prior Japanese Patent Application No. 2009-103806, filed on Apr. 22, 2009, the entire contents of which are incorporated herein by reference.

### FIELD

The embodiment discussed herein is a transmission apparatus, a method for transmission, and a transmission system. The transmission system is exemplified by one including a working path and a protection path.

### BACKGROUND

Examples of a technique to provide wide area Ethernet (registered trademark) are IEEE (Institute of Electrical and Electronic Engineers) 802.1ah PBB (Provider Backbone Bridge), and IEEE 802.1Qay PBB-TE (PBB-Traffic Engineering).

The technique of PBB encapsulates and relays users' Ethernet (registered trademark) frames in MAC-in-MAC scheme and is standardized in IEEE 802.1ah. The MAC-in-MAC scheme is an Ethernet (registered trademark) technique that encapsulates a MAC (Media Access Control) frame through the use of a MAC frame and transmits the resultant MAC frame.

PBB Network:

Here, FIG. 1 illustrates an example of configuration of a network (PBB network) in conformity with the PBB scheme.

As illustrated in FIG. 1, a network 100 exemplarily includes PBNs (Provider Bridged Networks) 200 and a PBBN (Provider Backbone Bridged Network) 300. A PBN 200 is one of the networks standardized in IEEE 802.1ad, and the PBBN 300 is a network in conformity with the PBB scheme and serves as a backbone network that accommodates and couples the PBNs 200.

The PBBN 300 includes BEBs (Backbone Edge Bridges) 400 serving as edge nodes and a BCB (Backbone Core Bridge) 500 serving as a relay node. The BCB 500 relays a user frame received in a BEB 400 to another BCB 500 or BEB 400.

In the MAC-in-MAC scheme, a user frame is encapsulated through the use of address information (e.g., a MAC address) available in the PBBN 300 and is then transmitted, so that each of the nodes 400 and 500 accommodated in the PBBN 300 leans the MAC address of a BEB 400 positioned at the edge (the ingress or the egress) of the PBBN 300 and is consequently capable of transmitting the user frame.

For this purpose, a BEB 400 has a function of, for example, encapsulating a user frame received from another network (a PBN 200, a PBBN 300, and others) through the use of a MAC frame and forwarding the encapsulated user frame (hereinafter called PBB frame) to the inside the PBBN 300. Conversely, a BEB 400 has a function of decapsulating a PBB frame received from the BCB 500 and forwarding a user frame extracted through the decapsulating to another network (a PBN 200, a PBBN 300, and others).

Further, a BCB 500 forwards a PBB frame received from a BEB 400 or another BCB 500 to an appropriate route on the basis of the Backbone-Destination MAC Address (B-DA) and the Backbone VLAN ID (B-VID) for route recognition which are set in the same PBB frame (bridging).

PBB Frame Format:

Here, FIG. 2 illustrates an example of the PBB frame format.

As illustrated in FIG. 2, the PBB scheme encapsulates a frame (user data) having a four-byte S-TAG, a four-byte C-TAG, a two-byte EtherType, a variable-length (or fixed-length) Payload, and a two-byte FCS through the use of a 18-byte I-TAG (Backbone Service Instance TAG), a four-byte B-TAG (Backbone VLAN TAG), a six-byte B-DA (B-MAC DA), and a six-byte Backbone-Source MAC Address (B-SA or B-MAC SA). “S-TAG” represents Service VLAN TAG; “EtherType” represents the type of Ethernet (registered trademark); and “FCS” is data bits of Frame Check Sequence.

“B-SA” is address information of the source of the PBB frame, and can be, for example, the MAC address of a BEB (Ingress BEB, IBEB) 400 positioned at the entrance of the PBBN 300. “B-DA” is address information of the destination of the PBB frame, and can be, for example, the MAC address of a BEB (Egress BEB, EBEB) 400 positioned at the exit of the PBBN 300.

“B-TAG” has the same format as that of S-TAG which is defined in IEEE 802.1ad and consists of a two-byte B-TAG TPID (Tag Protocol Identifier) and a two-byte B-TAG TCI (Tag Control Information). “B-TAG TCI” includes a 12-bit B-VID.

“I-TAG” consists of a two-byte (16-bit) I-TAG TPID for discriminating the kind of tag, a 16-byte (128-bit) I-TAG TCI. I-TAG TPID is a Tag Protocol Identifier. I-TAG TCI consists of a three-bit I-PCP (Priority Code Point), a one-bit I-DEI (Drop Eligible Indication: preferential discarding indication), a one-bit UCA (User Customer Address), a three-bit Res (Reserved: reserved region), a 24-bit I-SID(Service Instance Identifier), and the above-described 48-bit user MAC addresses (C-MAC DA, C-MAC SA). In the fields of the I-TAG TPID and the B-TAG TPID, the default values “0x88e7” and “0x88a8” defined by the IEEE are respectively set.

IEEE 802.1ad discriminates each user with reference to a 12-bit VLAN-ID (B-VID), but IEEE 802.1ah PBB is afforded to discriminate 2²⁴ (about 16 millions) users at the maximum through the use of a 24-bit I-SID.

Example of Setting ESP (Ethernet (Registered Trademark) Switched Path):

As expanded PBB, IEEE 802.1Qay standardizes PBB-TE. Here, the term “TE” represents a technique of controlling traffic routes, aiming at optimizing the network resource and improving forwarding efficiency of the traffic.

The technique of PBB-TE is characterized by, for example, relaying user frame using the PBB frame format; not requiring learning MAC addresses, discarding frames of unknown destinations; and forming a one-way path (ESP).

Transmission apparatuses (a BEB 400 and a BOB 500) accommodated in a network conforming with the PBB-TE scheme determines the forwarding route of a PBB frame on the basis of, for example, the B-VID and the B-DA set in the PBB frame in the same manner as the PBB scheme. For example, a BEB 400 and a BCB 500 each forward a PBB frame on the basis of static routing information (e.g., information about ESP) registered in a filtering database (FDB) possessed by the node itself. Routing information registered in the FDB is static information previously registered and is not sometimes dynamically learned.

The ESP is discriminated on the basis of, for example, the B-VID, the B-DA, and the B-SA. Thereby, a number of ESPs can be established between a pair of BEBs 400 (having the same combination of B-DA and the B-SA) by setting the different B-VIDs for the BEBs 400.

Here, an example of setting ESPs is illustrated in FIG. 3.

The network 100 illustrated in FIG. 3 includes BEBs 400-1 through 400-3 and BCBs 500-1 through 500-4. In the network, each ESP exemplarily starts from the BEB 400-1 (B-MAC SA=X).

The four ESPs (see the broken arrows) denoted in FIG. 3 start from the same node BEB 400-1, and therefore the MAC address “X” of the BEB 400-1 is set for the B-SA of all the ESPs.

The B-DA set for two ESPs which terminate at a BEB 400-2 (having a MAC address “Y”) is “Y” and the B-DA set for two ESPs which terminate at a BEB 400-3 (having a MAC address “Z”) is “Z”.

Further, B-VID=7 is set for the ESP which passes through the BEB 400-1, the BCBs 500-1 and 500-2, and the BEB 400-2 while B-VID=8 is set for the ESP which passes through the BEB 400-1, BCBs 500-1 and 500-4, and the BEB 400-2.

B-VID=7 is set for the ESP which passes through the BEB 400-1, the BCBs 500-1 and 500-4, and the BEB 400-3 while B-VID=8 is set for the ESP which passes through the BEB 400-1, the BCBs 500-3 and 500-4, and the BEB 400-3.

Even when ESPs have the same B-SA and the same B-DA as the above, setting different B-VIDs for the ESPs makes it possible to differentiate the ESPs from one another in the network 100.

Method for Protection in PBB-TE Scheme:

When a failure is detected on a route between transmission apparatuses 400 and 500 constituting an ESP, the forwarding route of frames is controlled such that the route of forwarding a frame is switched from the working path to the protection path (protection).

As a method of protection in the PBB-TE scheme, IEEE 802.1Qay proposes, for example, a path protection scheme.

An example of the path protection scheme is illustrated in FIG. 4.

The PBB-TE network 600 illustrated in FIG. 4 exemplarily includes BEBs 400-1 (N1), 400-2 (N5), and 400-3 (N8) and BCBs 500-1 (N2), 500-2 (N3), 500-3 (N4), 500-4 (N6), and 500-5 (N7).

In the PBB-TE network 600, an ESP passing through the nodes N1, N2, N3, N4, and N5 is prepared for the working path and an ESP passing through the nodes N1, N2, N6, N7, N4, and N5 is prepared for the protection path, for example.

In forwarding a frame through the working path in the PBB-TE network 600, the node N1 encapsulates a user frame which is received from another network (a PBN, a PBBN, or the like) through the use of the EBB frame format and then forwards the PBB frame to the next node (N2). Upon receipt of the PBB frame from the node N1, the node N2 forwards the received PBB frame to the next node (N3) on the working path on the basis of the B-VID and the B-DA set in the PBB frame and of the FDB possessed by the node (N2) itself. The nodes N3 and N4 carry out the same forwarding processing as that performed in the node N2, and consequently, the PBB frame is forwarded to the next nodes (N4 and N5) on the working path, respectively.

Then, upon receipt of the PBB frame from the node N4, the node N5 detects the coincidence between the B-DA set in the received PBB frame and the MAC address of the node (N5) itself and decapsulates the PBB frame to extract the user frame, which then the node N5 forwards to another network (e.g., a PBN or a PBBN).

In the meantime, in the event of occurrence of a failure (such as disconnection) on the route between the nodes N2 and N3, the nodes N2 detects the failure and notifies the nodes N1 of the occurrence of the failure. Upon receipt of the notification from the node N2, the node N1 changes (rewrites) the B-VID of the PBB frame to accomplish the control of switching the frame transmitting path from the working path (working ESP) to the protection path (protection ESP).

Since the B-SA and the B-DA of the protection path are set to be the same values as those of the working path (for example, the MAC address of the node N1 and the MAC address of the node N5), respectively, the B-VID of the protection path is set to be a value different from that of the working path so that the working path and the protection path can be determined to be different paths (discriminated from each other).

After the node N1 changes the value of the B-VID of the PBB frame, the node N1 forwards the PBB frame to the next node (N6) on the protection path on the basis of the new value of B-VID and the FDB. For example, FDB associates the new value of B-VID with the protection path. The nodes N6, N7, and N4 carry out the same forwarding processing as that performed in the node N1 and consequently forward the PBB frame to next nodes (N7, N4, and N5, respectively) on the protection path.

Upon receipt of the PBB frame from the node N4, the node N5 detects the coincidence between the B-DA set in the received PBB frame and the MAC address of the node (N5) itself and decapsulates the PBB frame to extract the user frame, which then the node N5 forwards to another network (e.g., a PBN or a PBBN).

Even when a failure occurs in a route between nodes, the path protection scheme can switch the transmission route of a PBB frame through changing the value of the B-VID frame by the IBEB 400-1 (N1) as the above. Consequently, the PBB frame can be transmitted, detouring the section on which the failure is occurring.

On the contrary, ITU-T G.8031 studies a segment protection scheme as a method for protection in the PBB-TE scheme.

An example of a segment protection scheme is illustrated in FIG. 5.

In the segment protection scheme as illustrated in FIG. 5, in the event of occurrence of a failure on the route between the nodes N2 and N3, the nodes (e.g., N2) which detects the failure changes the value of B-VID of the PBB frame and thereby forwards the PBB frame to the protection path (which passes through the nodes N2, N6, N7, and N3 in FIG. 5), detouring the route (failure segment) on which the failure is occurring.

Alternatively, the other node (e.g., N3) disposed at the terminal end of the segment at which the failure occurs may restore the B-VID changed by the node N2 in order to forward the PBB frame to the path (part of the working path) passing through the nodes N3, N4, and N5.

Since the above path protection scheme causes the IBEB 400-1 to carry out control of switching the route, disconnection continues until the occurrence of the failure is notified to the IEEE 400-1 since the occurrence of the failure and therefore the PBB frame may not be normally transmitted.

On the other hand, the segment protection scheme causes one (the node N2 in FIG. 5) of the nodes between which a failure occurs to carry out control of switching the route, it is possible to shorten the time period of disconnection as compared to the path protection scheme.

As the technique of switching path, Patent Literature 1 below discloses a method for switching path in a network routing device that stays resident in a multicast dispersion environment.

Following Patent Literature 2 discloses a method in which nodes on the working path are divided into a number of segments each including a number of nodes, and the position information of each segment is notified by a working path setting request message so that a protection path which couples the start node and the end node of each segment is established.

Further, Patent literature 3 discloses a method in which, in the event of occurrence of a failure of one on the nodes included in a network, another node (master node) acts as the failure node (slave node).

Patent Literature 4 discloses a method for rapidly establishing, in the event of occurrence of a failure on a link in a network including nodes coupled to one another to form a loop, a route detouring the site of the failure through the use of the loop.

### Prior Art Reference

[Patent Literature]

[Patent Literature 1] Japanese Laid-open Patent Publication No. 2006-229967

[Patent Literature 2] Japanese Laid-open Patent Publication No. 2005-277446

[Patent Literature 3] Japanese Laid-open Patent Publication No. H11-220466

[Patent Literature 4] Japanese Laid-open Patent Publication No. 2000-278351

As described above, each protection scheme causes a transmission apparatus to change the route of forwarding a PBB frame through varying the B-VID of the PBB frame.

However, B-VID is data of only 12 bits, setting a number of paths may exhaust the label space of the B-VID.

Consequently, the degree of freedom in path setting declines, accompanying a decline in scalability (extensibility) of the network.

### SUMMARY

(1) According to the first aspect of the invention, a transmission apparatus which transmits a frame through a working path and a protection path, including: a detecting unit which detects a failure occurring on the working path; a controller which, when the detecting unit detects the failure, changes a first destination address in the frame to a second destination address different from the first destination address and transmits the frame to the protection path.

(2) According to the second aspect of the invention, a method for transmitting a frame through a working path and a protection path, including: detecting a failure occurring on the working path; changing a first destination address in the frame to a second destination address in accordance with the result of the detecting; and transmitting the frame after the changing to the protection path.

(3) As the third aspect of the invention, a transmission system comprising a transmission apparatus which transmits a frame through a working path and a protection path, the system including: a detecting unit which detects a failure occurring on the working path; a controller which, when the detecting unit detects the failure, changes a first destination address in the frame to a second destination address different from the first destination address and transmits the frame to the protection path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of the configuration of the network;

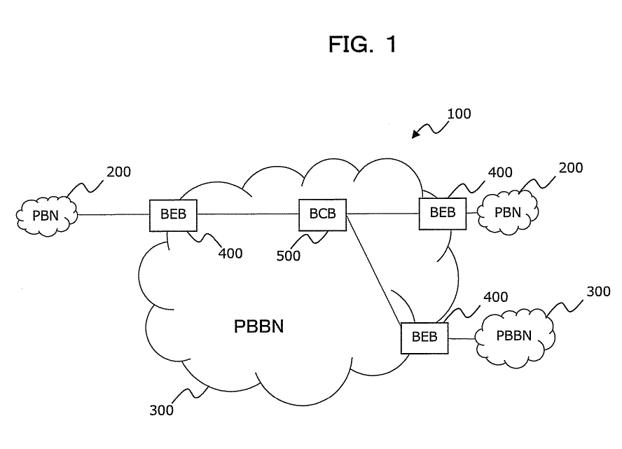

FIG. 2 is a diagram illustrating an example of a PBB frame format;

FIG. 3 is a diagram illustrating an example of setting an ESP;

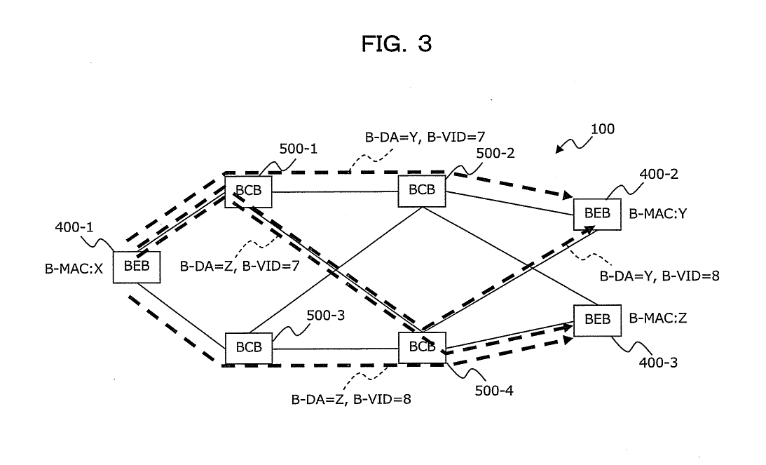

FIG. 4 is a diagram illustrating an example of a path protection scheme;

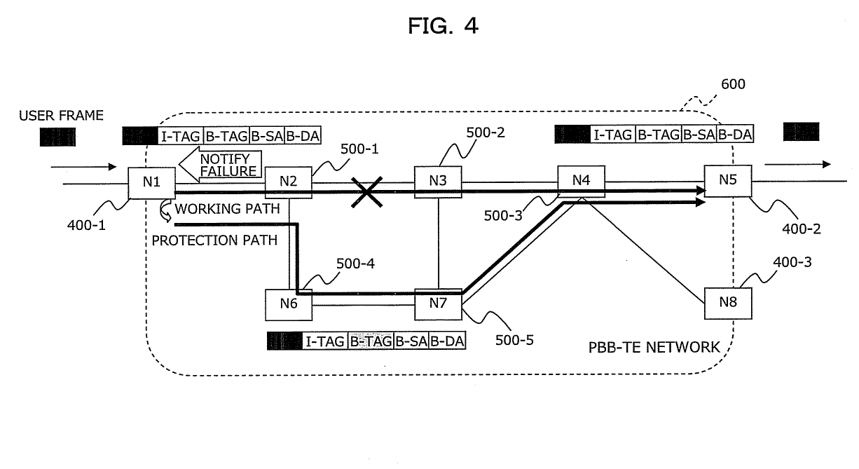

FIG. 5 is a diagram illustrating an example of a segment protection scheme;

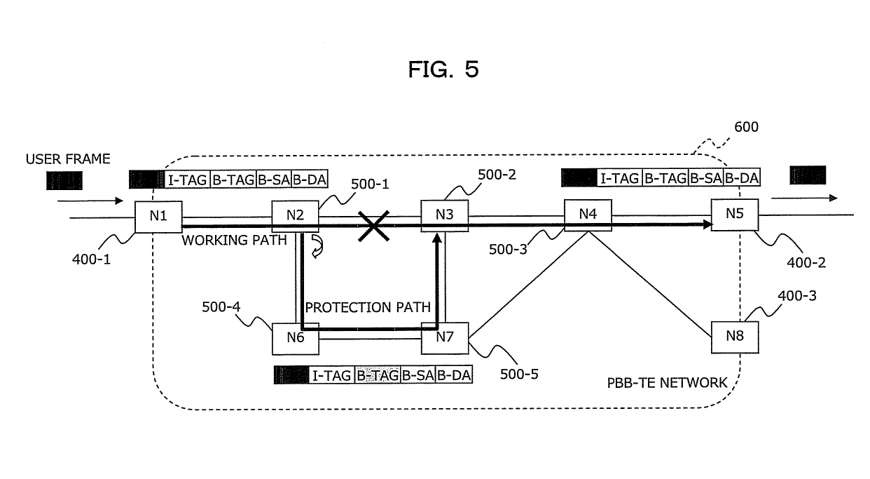

FIG. 6 is a diagram illustrating an example of a network according to an embodiment;

FIG. 7 is a block diagram schematically illustrating an example of the configuration of a transmission apparatus of an embodiment;

FIG. 8 is a flow diagram illustrating an example of operation of a transmission apparatus of FIG. 6;

FIG. 9 is a flow diagram illustrating another example of operation of a transmission apparatus of FIG. 6;

FIG. 10 is a diagram illustrating an example of a table possessed by a transmission apparatus (N2) of FIG. 6;

FIG. 11 is a diagram illustrating another example of a table possessed by a transmission apparatus (N2) of FIG. 6;

FIG. 12 is a diagram illustrating an example of a table possessed by a transmission apparatus (N3) of FIG. 6;

FIG. 13 is a schematic diagram illustrating an example of a network of an embodiment;

FIG. 14 is a diagram illustrating an example of a table possessed by a transmission apparatus (N7) of FIG. 13;

FIG. 15 is a diagram illustrating an example of a table possessed by the transmission apparatus (N3) of FIG. 6;

FIG. 16 is a schematic diagram illustrating an example of a network of an embodiment;

FIG. 17 is a diagram illustrating an example of a table possessed by a transmission apparatus (N7) of FIG. 16;

FIG. 18 is a diagram illustrating an example of a table possessed by a transmission apparatus (N3) of FIG. 16;

FIG. 19 is a diagram illustrating an example of the structure of a MAC address;

FIG. 20 is a diagram illustrating an example of operation of a transmission apparatus according to a first modification;

FIG. 21 is a diagram illustrating another example of operation of a transmission apparatus according to the first modification;

FIG. 22 is a diagram illustrating an example of a table of the transmission apparatus (N2) of the first modification;

FIG. 23 is a diagram illustrating another example of a table of the transmission apparatus (N3) of the first modification;

FIG. 24 is a diagram illustrating an example of a table of the transmission apparatus (N2) of the first modification;

FIG. 25 is a diagram illustrating an example of a table of the transmission apparatus (N6) of the first modification; and

FIG. 26 is a schematic diagram illustrating an example of a network according to a second modification.

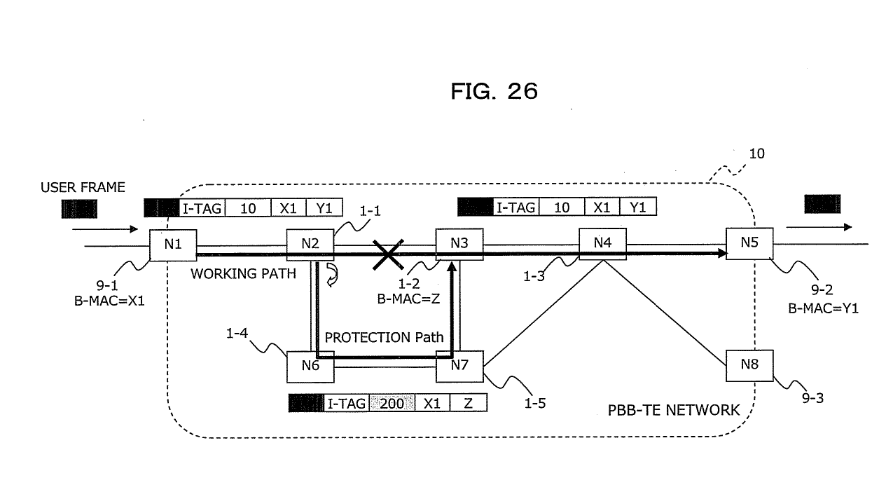

### DESCRIPTION OF EMBODIMENTS

Hereinafter, exemplary embodiments will be described with reference to accompanying drawings. The following exemplary embodiment is merely an example and does not intend to exclude various modifications and variations to the proposed method and/or apparatus that are not specifically described herein. Rather, various modifications or variations may be made to the embodiment (for example, by combining the exemplary embodiments) without departing from the scope and spirit of the proposed method and/or apparatus.

(1) An Embodiment:

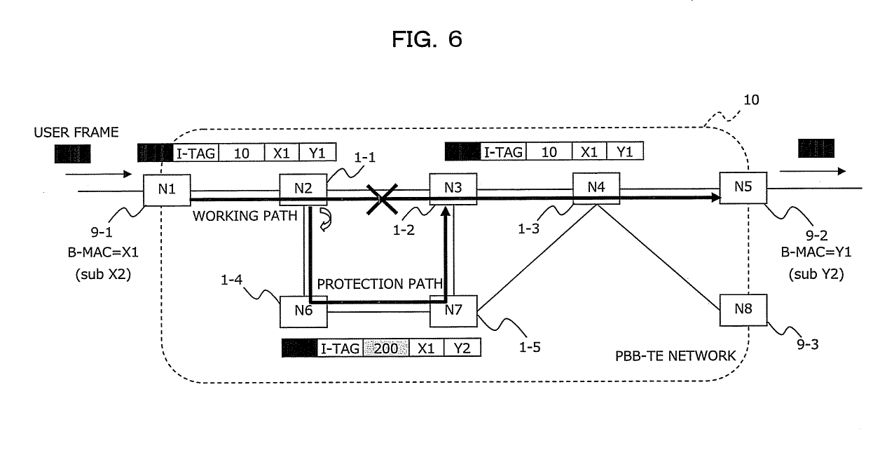

FIG. 6 is a schematic diagram illustrating an example of a network of the embodiment.

The network (PBB-TE network) 10 of FIG. 6 exemplarily includes, a BEB 9-1 (N1), a BEB 9-2 (N5), a BEB 9-3 (N8), a BCB 1-1 (N2), a BCB 1-2 (N3), a BCB 1-3 (N4), a BCB 1-4 (N6), and a BCB 1-5 (N7). Hereinafter, the BEBs 9-1 through 9-3 are sometimes simply called the BEBs 9 when not discriminating one from the others; and similarly, the BCBs 1-1 through 1-5 are sometimes simply called the BCBs 1 when not discriminating one from the others. The number of BEBs 9, the number of BCBs 1, and the coupling manner in the network 10 should by no means be limited to those of FIG. 6.

The PBB-TE network 10 prepares, for example, the working path (working ESP) that passes through the nodes N1, N2, N3, N4, and N5, and the protection path (protection ESP) that passes through the nodes N2, N6, N7, and N3.

A number of MAC addresses (destination addresses) are set for the EBEB 9-2 (N5). In the example of FIG. 6, the node N5 possesses the main address (first destination address) “Y1” and a sub-address (second destination address) “Y2” different from the main address. The number of MAC addresses is not limited to this. Alternatively, it is satisfactory that at least the EBEB 9-2 (N5) that is positioned at the terminal end of the working path has a number of destination addresses (MAC addresses). For example, the nodes N1 and N5 (or N8) may each have three or more MAC addresses, and alternatively only the node N5 (N8) may have a number of MAC addresses. For example, in the network 10 of FIG. 6, a number of MAC addresses are set for the IBEB 9-1 (N1), which has the main address “X1” and a sub-address “X2”.

(1.1) Control of Switching the Transmission Path:

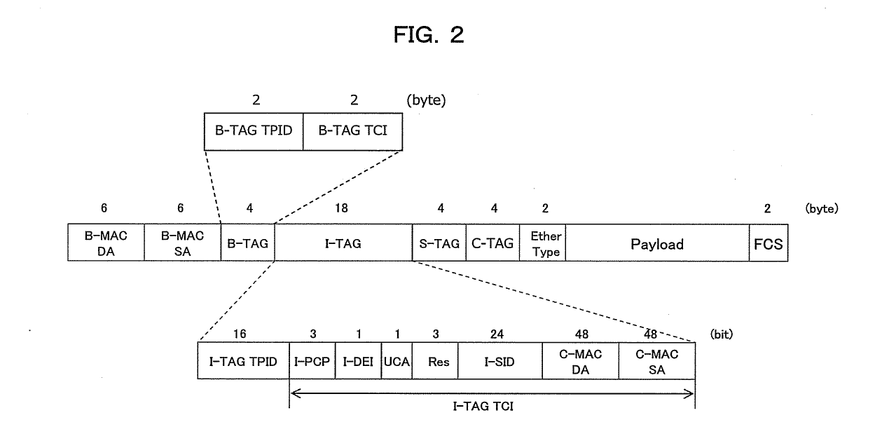

In forwarding a PBB frame through the working path in the PBB-TE network 10, the node N1 firstly encapsulates a user frame received from another network (such as a PBN, a PBBN, and others) through the use of the PBB frame format illustrated in FIG. 2. For example, the node N1 encapsulates the user frame through providing the MAC address “X1” of the node N1 itself to the user identifiers I-SID and B-SA, providing the MAC address “Y1” of the EBEB (N5) of the working path to the B-DA and providing the value “10” to the B-VID (the route identifier). Then, the node N1 forwards the PBB frame to the next relay node (N2) on the working path (see Working Path in FIG. 6) on the basis of the B-VID “10” and the B-DA “Y1” set in the PBB frame and the FDB possessed by the node (N1) itself.

Upon receipt of the PBB frame from the node N1, the node N2 selects the route corresponding to the B-VID “10” and the B-DA “Y1” set in the received PBB frame with reference to the FDB, and forwards the PBB frame to the next relay node (N3) on the selected route (i.e., the working path). The nodes N3 and N4 carry out the same forwarding processing as that performed in the node N2, and consequently forward the PBB frame to the next relay nodes (N4 and N5, respectively).

Upon receipt of the PBB frame from the node N4, the node N5 detects that the MAC address “Y1” of the node (N5) itself is set in the B-DA of the received PBB frame and performs the terminal processing on the PBB frame. At that time, the node N5 decapsulates the PBB frame by removing the B-TAG, the B-DA, the B-SA, and I-TAG from the PBB frame and thereby extracts (creates) the user frame, which then the node N5 forwards to the another network (such as a PBN, a PBBN, and others).

As described above, also the embodiment can carry out relay processing of a PBB frame through the working path when no failure occurs.

On the other hand, in the event of occurrence of a failure (e.g., disconnection) between the nodes N2 and N3, the node N2 detects the failure. The node N2 may carry out alarm processing against the detected failure.

The node N2, which detects the failure, changes the B-VID “10” (a first route identifier) set in the PBB frame received from the N1 to the “200” (a second route identifier) and also changes the B-DA “Y1” to “Y2”.

After that, the node N2 selects the route (Protection Path in FIG. 6) corresponding to the B-VID “200” and the B-DA “Y2” of the PBB frame on the basis of the FDB, and forwards the next relay node (N6) disposed on the selected route.

As described above, the embodiment can grasp, on the basis of the value of the B-DA in a PBB frame, whether the forwarding destination of the PBB frame is the working path or the protection path.

In addition, the node (N2) which detects the failure switches the transmission path of the PBB frame from the working path to the protection path by changing the B-VID and the B-DA of the PBB frame, which thereby enhances the degree of freedom in setting the path and improves the scalability of the network 10. As substitute for changing both B-VID and B-DA, changing only the 48-bit B-DA results in the same.

Upon receipt of the PBB frame from the node N2, the node N6 selects the route corresponding to the B-VID “200” and the B-VID “Y2” set in the received PBB frame on the basis of the FDB, and forwards the PBB frame to the node N7, which is the next relay node on the selected route. The node N7 carries out the same forwarding processing as that performed by the node N6 and consequently forwards the PBB frame to the next relay node (N3) on the protection path.

Upon receipt of the PBB frame from the node N7, the node N3 may restore the changed B-VID “200” and B-DA “Y2” of the PBB frame to the original B-VID “10” and B-DA “Y1”, respectively. Thereby, the node N3 selects the route (the working path) corresponding to the B-VID “10” and the B-DA “Y1” set in the PBB frame on the basis of the FDB, and forwards the PBB frame to the node N4, which is the next node on the selected path.

Upon receipt of the PBB frame from the node N3, the node N4 selects the route corresponding to the B-VID “10” and the B-DA “Y1” set in the received PBB frame on the basis of the FDB, and forwards the PBB frame to the node N5, which is the next node on the selected path.

Upon receipt of the PBB frame from the node N4, the node N5 detects that the B-DA in the received PBB frame is set to be the MAC address “Y1” of the node (N5) itself, and carries out terminal processing on the PBB frame. At that time, the node N5 decapsulates the PBB frame by removing the B-TAG, the B-DA, the B-SA, and I-TAG from the PBB frame and thereby extracts (creates) the user frame, which then the node N5 forwards to the another network (such as a PBN, a PBBN, and others).

As described above, the embodiment switches the route of forwarding a PBB frame through changing the B-VID and the B-DA of the PBB frame by the node (e.g., N2) that detects the failure under a circumstance where a number of destination addresses (e.g., MAC addresses) are set for at least the EBEB 9-2.

This makes it possible to set the path, using the six-byte (48-bit) B-DA in addition to the 12-bit B-VID, so that the number of paths can greatly increase, enhancing the degree of freedom in setting the path and improving the scalability of the network.

(1.2) Example of Node Configuration:

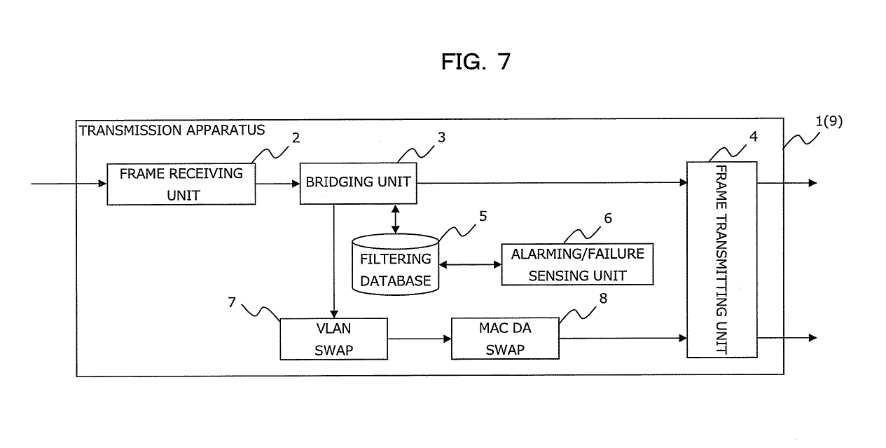

Next, description will now be made in relation to an example of the configuration of a transmission apparatus (node) of the first embodiment with reference to FIG. 7.

A node 1 (9) illustrated in FIG. 7 is a transmission apparatus which transmits a PBB frame through the working path and the protection path, and exemplarily includes a frame receiving unit 2, a bridging unit 3, a frame transmitting unit 4, an FDB (Filtering DataBase) 5, an alarming/failure-sensing unit 6, a B-VID converting unit (VLAN SWAP) 7, and a B-DA converting unit (MAC DA SWAP) 8.

The frame receiving unit 2 receives a user frame from a network and a PBB frame from another node. For example, assuming that the node 1 (9) is an IBEB 9, the frame receiving unit 2 receives a user frame from another network and encapsulates the received user frame into a PBB frame; assuming that the node 1 (9) is a BCB 1, the frame receiving unit 2 receives a PBB frame from another node 1 (9); and assuming that the node 1 (9) is an EBEB 9, the frame receiving unit 2 receives a PBB frame from another node and decapsulates the received PBB frame to extract a user frame. A frame received by the frame receiving unit 2 is sent to the bridging unit 3. The following description assumes that the node 1 (9) is a BCB 1, but the node is not limited to this. In other words, there is no intention to exclude cases where the node 1 (9) is BEB 9.

The bridging unit 3 sends a PBB frame input from the frame receiving unit 2 to the frame transmitting unit 4 or the B-VID converting unit 7 on the basis of the contents of a table stored in the FDB 5. For example, when the alarming/failure-sensing unit 6 detects a failure, the bridging unit 3 sends the PBB frame to the B-VID converting unit 7; while the alarming/failure-sensing unit 6 detects no failure, the bridging unit 3 sends the PBB frame to the frame transmitting unit 4.

Specifically, while the alarming/failure-sensing unit 6 detects no failure, the bridging unit 3 sends the received PBB frame to the working path on the basis of the B-DA (e.g., the main address of the EBEB 9-2) possessed by the PBB frame without changing the B-VID and B-DA (or only B-DA).

The FDB 5 stores a table that has entries each associating the values of the B-VID and the B-DA set in the PBB frame with the output destination (output port) of the PBB frame. Each entry in the table includes: an available flag which represents whether the entry is Available or Not Available (NA); indication as to whether or not the B-VID and the B-DA are rewritten (changed); and the contents of rewrite. For example, under a state in which the network 10 is operating normally, “Available” is set in the available flag of an entry for which an output port coupled to the working path is set while “NA” is set in the available flag of an entry for which an output port coupled to the protection path is set. In the meantime, in the event of occurrence of a failure in the network 10, “NA” is set in an entry for which an output port coupled to the working path is set while “Available” is set in an entry for which an output port coupled to the protection path is set.

The alarming/failure-sensing unit (detecting unit) 6 senses (detects) a failure occurring on a route (e.g., a working path) coupled to the node. In addition, the alarming/failure-sensing unit 6 is capable of changing (updating) the contents of the table in the FDB 5 on the basis of the information about the detected failure. For example, the alarming/failure-sensing unit 6 retrieves the presence/absence of an entry corresponding to an output port coupled to a route on which the failure is occurring, and if the corresponding entry is detected, changes the Available flag of the entry to “NA”. Further, using the B-DA and the B-VID of the same entry as retrieval keys, the available flags of one or more entries detected as the result of the retrieval are changed into “Available”. After the updating of the table, the bridging unit 3 can detour the PBB frame, for example, from the output port coupled to a route on which the failure is occurring to another port with reference to the updated table contents.

The B-VID converting unit 7 changes the B-VID of the PBB frame input from the bridging unit 3 on the basis of the contents of the table in the FDB 5. The PBB frame whose B-VID is changed by the B-VID converting unit 7 is sent to the B-DA converting unit 8.

The B-DA converting unit 8 changes the B-DA of the PBB frame input from the B-VID converting unit 7 on the basis of the contents of the table in the FDB 5. The PBB frame whose B-DA is changed by the B-DA converting unit 8 is sent to the frame transmitting unit 4.

The frame transmitting unit 4 forwards the PBB frames input from the bridging unit 3 and the B-DA converting unit 8 to routes (the working path or the protection path) associated with the B-VID and the B-DA set in received PBB frames.

In other words, the bridging unit 3, the B-VID converting unit 7, the B-DA converting unit 8, and the frame transmitting unit 4 collectively function as an example of a controller that changes, when a failure is detected by the alarming/failure-sensing unit 6, the first destination address (Y1) possessed by the PBB frame to the second destination address (Y2) and sends the PBB frame to the protection path.

(1.3) Example of Operation of Node 1:

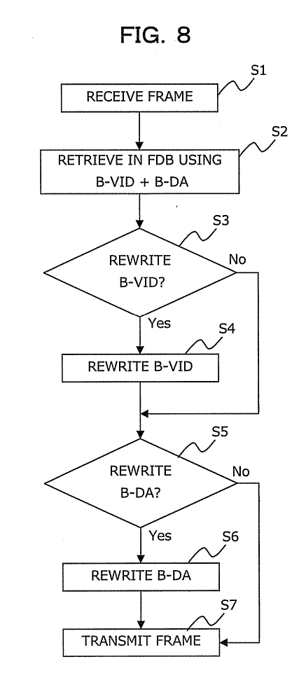

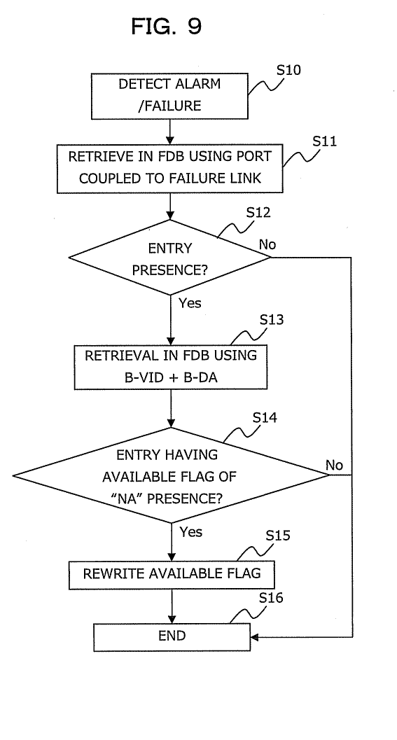

Next, description will now be made in relation to an example of operation of the node 1 with reference to FIGS. 8 and 9. As illustrated in FIG. 8, firstly, the frame receiving unit 2 of the node 1 receives a PBB frame from another node 1 (9) (step S1).

Subsequently, the bridging unit 3 retrieves an entry from the table possessed by the FDB 5, using the B-VID and the B-DA set in the received PBB frame as the retrieval keys (step S2). The retrieval result may not include an entry having an available flag set to be “NA”.

Then, the bridging unit 3 judges whether the B-VID rewrite field of the entry obtained through the retrieval is available (step S3). If the rewrite is available (Yes route in step S3), the bridging unit 3 sends the PBB frame to the B-VID converting unit 7, which rewrites the B-VID of the PBB frame (step S4). Conversely, if the B-VID rewrite field of the entry obtained by the retrieval is not available (No route in step S3), the B-VID is not rewritten.

After that, the bridging unit 3 judges whether the B-DA rewrite of the entry obtained through the retrieval is available (step S5). If the rewrite is available (Yes route in step S5), the bridging unit 3 sends the same PBB frame to the B-DA converting unit 8, which rewrites the B-DA of the PBB frame (step S6). Then, the frame transmitting unit 4 sends the PBB frame whose B-DA is rewritten to the next node (step S7).

On the contrary, if the B-DA rewrite of the entry obtained through the retrieval is not available (No route in step S5), the node 1 prompts the frame transmitting unit 4 to send the PBB frame to the next node without rewriting the B-VID (step S7). The processes of the above steps S3 and S5 may be collectively accomplished in a single step and, in this case, the processes of the steps S4 and S6 may be accordingly accomplished in a single step.

If the alarming/failure-sensing unit 6 detects a failure (or an alarm) (step S10) as denoted in FIG. 9, the alarming/failure-sensing unit 6 retrieves an entry from the table in the FDB 5 (step S11), using an output port coupled to the link (route) on which the detected failure is occurring as a retrieval key. The retrieval result may not include an entry having an available flag set to be “NA”.

Then the alarming/failure-sensing unit 6 judges whether or not the retrieval obtains an entry (step S12), and if it concludes that the retrieval obtains no entry (No route in step S12), the alarming/failure-sending unit 6 terminates the procedure (step S16).

Conversely, if the retrieval concludes that the retrieval obtains an entry (Yes route in step S12), the alarming/failure-sensing unit 6 further retrieves another entry from the table in the FDB 5 (step S13), using the B-VID and the B-DA of the entry obtained in step S12 as retrieval keys.

Next, the alarming/failure-sensing unit 6 judges whether or not the retrieval instep S13 detects an entry having an available flag set to be “NA” (step S14). If the alarming/failure-sensing unit 6 concludes the absence of such an entry (No route instep S14), the alarming/failure-sensing unit 6 terminates the procedure (step S16).

On the other hand, if the retrieval in step S13 detects an entry having an available flag set to be “NA” (Yes route in step S14), the alarming/failure-sensing unit 6 changes (rewrites) the available flag of the detected entry from “NA” to “Available” (step S15). The alarming/failure-sensing unit 6 further changes the available flag of the entry detected in step S12 from “Available” to “NA” (step S15) and terminates the procedure (step S16).

As described above, the node 1 can control the destination of forwarding the PBB frame in accordance with the contents of the table in the FDB 5. Additionally the node N1 change the contents of the table when detecting a failure and changes the B-VID and the B-DA of the PBB frame so that the route of forwarding the PBB frame can be switched between the working path and the protection path.

Further, since a path is recognized with reference to the B-VID and the B-DA of the PBB frame, a larger number of paths can be recognized as compared with the cases where paths are recognized with reference only to the B-VID. This can increase the degree of freedom in setting paths and improves the scalability of the network.

(1.4) Example of Operation of Network (PBB-TE Network) 10:

Here, description will now be made in relation to an example of operation of the PBB-TE network 10 including the above node 1.

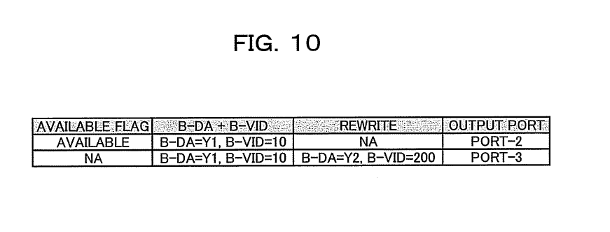

FIG. 10 illustrates an example of a table possessed by the node N2 under a circumstance where the PBB-Te network 10 of FIG. 6 is normally operating.

This table exemplarily includes a first entry in which the available flag “Available”, the B-DA+B-VID “B-DA=Y1, B-VID=10”, the rewrite “NA”, and the output port “Port-2” are associated with one another, and a second entry in which the available flag “NA”, the B-DA+B-VID “B-DA=Y1, B-VID=10”, the rewrite “B-DA=Y2, B-VID=200”, and the output port “Port-3” are associated with one another. The Port-2 is an output port of the node N2 that is coupled to the route (the working path) from the node N2 to the node N3, and the Port-3 is another output port of the node N2 that is coupled to the route (the protection path) from the node N2 to the node N6 in the configuration of FIG. 6.

In carrying out forwarding processing of a PBB frame on the basis of the table of FIG. 10, the node N2 firstly receives, at the frame receiving unit 2, the PBB frame from the node N1. In the PBB frame, the B-VID “10” and the B-DA “Y1” are set by the node N1.

Next, the node N2 retrieves a corresponding entry from the table of FIG. 10, using the B-VID “10” and the B-DA “Y1” set in the received PBB frame as retrieval keys.

As the result of retrieval, the node N2 detects the first entry in which the available flag is set to be “Available”, and further judges, on the basis of the rewrite field of the first entry, whether or not rewriting of the B-VID and the B-DA is available. In the example of FIG. 10, the rewrite field of the first entry is “NA (Not Available) ” and therefore the node N2 does not rewrite the B-VID and the B-DA of the PBB frame received from the node N1.

After that, the node N2 forwards the FEB frame to the output port “Port-2” that is coupled to the next node N3 on the basis of the value of the output port of the first entry.

For example, when the alarming/failure-sensing unit 6 detects a failure (or an alarm) on a route from the node N2 to the node N3, the node N2 retrieves a corresponding entry from the table of FIG. 10 using the output port “Port-2” coupled to the link (route) on which the failure is occurring as a retrieval key.

As the result of retrieval, the node N2 detects the first entry in which the available flag is set to be “Available”, and further retrieves another entry having an available flag set to be “NA” from the table of FIG. 10 using the B-VID “10” and the B-DA “Y1” of the first entry as retrieval keys.

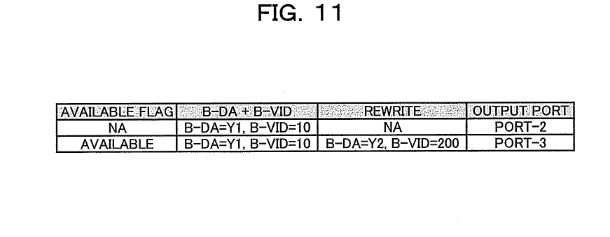

As the result of the latest retrieval, the node N2 detects the second entry, and changes the available flag of the second entry from “NA” to “Available” and also changes that of the first entry from “Available” to “NA” as the example FIG. 11 illustrates.

After that, the node N2 carries out a forwarding processing on the PBB frame on the basis of the table (table after the changing) of FIG. 11.

For example, upon receipt of the PBB frame from the node N1, the node N2 retrieves a corresponding entry from the table of FIG. 11, using the B-VID “10” and the B-DA “Y1” as retrieval keys.

As the result of retrieval, the node N2 detects the second entry in which the available flag is set to be “Available”, and further judges, on the basis of the rewrite field of the second entry, whether or not rewriting of the B-VID and the B-DA is available. In the example of FIG. 11, the rewrite field of the second entry is available to be “B-DA=Y2, B-VID=200” and the node N2 rewrites the B-VID and the B-DA of the PBB frame received from the node N1 from “10” and “Y1” to “200” and “Y2”, respectively. Then the node N2 forwards the PBB frame to the “Port-3” coupled to the next node N6 on the basis of the value of the output port of the second entry.

As described above, in the event of sensing a failure, the node N2 rewrites the B-VID and the B-DA of the PBB frame to switch the route of forwarding the PBB frame from the working path to the protection path.

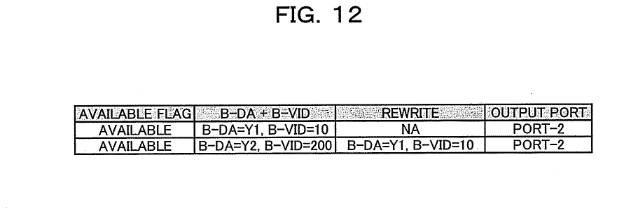

The node N3 that is the last node of the protection path may possess a table illustrated in FIG. 12.

The table of FIG. 12 exemplarily includes a first entry in which the available flag “Available”, the B-DA+B-VID “B-DA=Y1, B-VID=10”, the rewrite “NA”, and the output port “Port-2” are associated with one another, and a second entry in which the available flag “Available”, the B-DA+B-VID “B-DA=Y2, B-VID=200”, the rewrite “B-DA=Y1, B-VID=10”, and the output port “Port-2” are associated with one another. The Port-2 is an output port of the node N3 that is coupled to the route (the working path) from the node N3 to the node N6 in FIG. 6. Since the node N3 forwards PBB frames received through the working path and the protection path to the next node N4 on the working path, the available flags of the first and the second entries are both “Available”.

While no failure is occurring on a route between the nodes N2 and N3, the node N3 receives a PBB frame in which the B-VID and the B-DA are respectively set to be “10” and “Y1” from the node N2 through the working path.

Next, the node N3 retrieves a corresponding entry from the table of FIG. 12, using the B-VID “10” and the B-DA “Y1” set in the PBB frame as retrieval keys.

As the result of retrieval, the node N3 detects the first entry in which the available flag is set to be “Available”, and further judges, on the basis of the rewrite field of the first entry, whether or not rewriting of the B-VID and the B-DA is available. In the example of FIG. 12, the rewrite field of the first entry is “NA (Not Available)” and the node N3 does not rewrite the B-VID and the B-DA of the PBB frame received from the node N2.

Then, the node N3 forwards the PBB frame to the output port “Port-2” coupled to the next node N4 on the basis of the value of the output port of the first entry.

In the meantime, while a failure is occurring on the route between the nodes N2 and N3, the node N3 receives a PBB frame in which the B-VID and the B-DA are respectively set to be “200” and “Y2” from the node N7 through the protection path.

Next, the node N3 retrieves a corresponding entry from the table of FIG. 12, using the B-VID “200” and the B-DA “Y2” set in the received PBB frame as retrieval key.

As a result of the retrieval, the node N3 detects the second entry in which the available flag is set to be “Available”, and further judges, on the basis of the rewrite field of the second entry, whether or not rewriting of the B-VID and the B-DA is available. In the example of FIG. 12, the rewrite field of the second entry is available to be “B-DA=Y1, B-VID=10” and therefore the node N3 rewrites the B-VID and the B-DA of the PBB frame received from the node N7 from “200” and “Y2” to “10” and “Y1”, respectively. Then the node N3 forwards the PBB frame to the “Port-2” coupled to the next node N4 on the basis of the value of the output port of the second entry.

As detailed above, the end node N3 of the protection path is capable of forwarding a PBB frame received through the protection path to the working path.

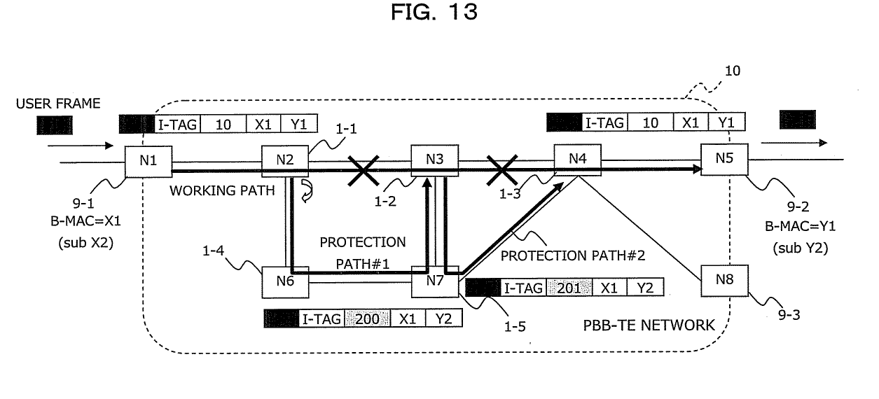

Referring to FIG. 13, in the event of occurrence of another failure on the route between the nodes N3 and N4 in addition to the failure occurring at the nodes N2 and N3, the PBB frame is transmitted through another protection path (Protection Path #2) that passes through the nodes N3, N7, and N4 different from the above protection path (Protection Path #1).

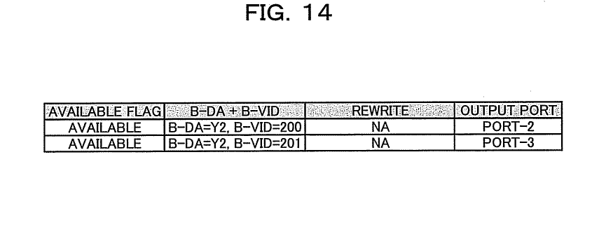

FIG. 14 is an example of a table possessed by the node N7 when failures are occurring at a route between the nodes N2 and N3 and a route between the nodes N3 and N4 in the PBB-TE network 10 of FIG. 13.

This table exemplarily includes a first entry in which the available flag “Available”, the B-DA+B-VID “B-DA=Y2, B-VID=200”, the rewrite “NA”, and the output port “Port-2” are associated with one another, and a second entry in which the available flag “Available”, the B-DA+B-VID “B-DA=Y2, B-VID=201”, the rewrite “NA”, and the output port “Port-3” are associated with one another. In FIG. 13, the Port-2 is an output port of the node N7 that is coupled to the route from the node N7 to the node N3, and the Port-3 is another output port of the node N7 that is coupled to the route from the node N7 to the node N4. The node N7 sets the B-VID of Protection Path #1 to be different from that of Protection Path #2 so that the FDB 5 recognizes Protection Paths #1 and #2 to be different from each other.

In carrying out forwarding processing of a PBB frame on the basis of the table of in FIG. 14, the node N7 firstly causes the frame receiving unit 2 to receive the PBB frame from the node N6.

Next, the node N7 retrieves a corresponding entry from the table of FIG. 14, using the B-VID “200” and the B-DA “Y2” set in the received PBB frame as retrieval keys.

As the result of retrieval, the node N7 detects the first entry in which the available flag is set to be “Available”, and further judges, on the basis of the rewrite field of the first entry, whether or not rewriting of the B-VID and the B-DA is available. In the example of FIG. 14, the rewrite field of the first entry is “NA (Not Available) ” and therefore the node N7 does not rewrite the B-VID and the B-DA of the PBB frame received from the node N6.

Then the node N7 forwards the PBB frame to the output port “Port-2” coupled to the next node N3 on the basis of the value of the output port in the first entry.

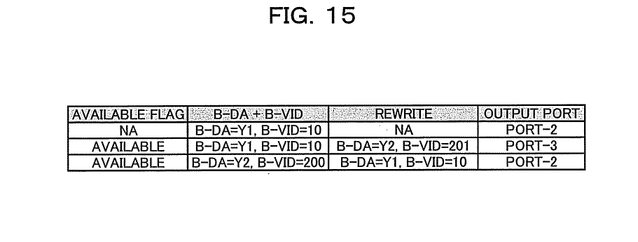

The node N3, which is the end node of Protection Path #1 and is the start node of Protection Path #2, possesses the table denoted in FIG. 15 when, for example, a failure is occurring on the route between the nodes N3 and N4.

The table of FIG. 15 exemplarily includes a first entry in which the available flag “NA”, the B-DA+B-VID “B-DA=Y1, B-VID=10”, the rewrite “NA”, and the output port “Port-2” are associated with one another, a second entry in which the available flag “Available”, the B-DA+B-VID “B-DA=Y1, B-VID=10”, the rewrite “B-DA=Y2, B-VID=201”, and the output port “Port-3” are associated with one another, and a third entry in which the available flag “Available”, the B-DA+B-VID “B-DA=Y2, B-VID=200”, the rewrite “B-DA=Y1, B-VID=10”, and the output port “Port-2” are associated with one another. In FIG. 13, the Port-2 is an output port of the node N3 that is coupled to the route (working path) from the node N3 to the node N4, and the Port-3 is another output port of the node N3 that is coupled to the route (protection path) from the node N3 to the node N7.

While no failure is occurring on the route between the nodes N3 and N4, the Node N3 changes the available flag of the first entry of the table in FIG. 15 from “NA” to “Available” and changes that of the second entry from “Available” to “NA” the node N3 directly forwards the PBB frame received from the node N2 or N7 to the node N4.

As illustrated in the example FIG. 13, while a failure is occurring on the route between the nodes N3 and N4, the node N3 receives the PBB frame in which the B-VID and the B-DA are respectively set to be “200” and the “Y2” from the node N7 through Protection Path #1.

Next, the node N3 retrieves a corresponding entry from the table of FIG. 15, using the B-VID “200” and the B-DA “Y2” set in the received frame as retrieval keys.

As the result of retrieval, the node N3 detects the third entry in which the available flag is set to be “Available”, and further judges, on the basis of the rewrite field of the third entry, whether or not rewriting of the B-VID and the B-DA is available. In the example of FIG. 15, the rewrite field of the third entry is available to be “B-DA=Y1, B-VID=10” and therefore the node N3 rewrites the B-VID and the B-DA of the PBB frame received from the node N7 from “200” and “Y2” to “10” and “Y1”, respectively.

Then the node N3 attempts to forward the PBB frame to the output port “Port-2” coupled to the next node N4 on the basis of the value of the output port of the third entry. However, since Port-2 (the link to the node N4) is down, the PBB frame is not sent to Port-2.

In this case, the node N3 again retrieves a corresponding entry from the table of FIG. 15, using the B-VID “10” and B-DA “Y1” after the rewrite as the retrieval keys.

As the result of the second retrieval, the node N3 detects the second entry in which the available flag is set to be “Available”, and further judges, on the basis of the rewrite field of the second entry, whether or not rewriting of the B-VID and the B-DA is available. In the example of FIG. 15, the rewrite field of the second entry is available to be “B-DA=Y2, B-VID=201” and therefore the node N3 rewrites the B-VID and the B-DA of the PBB after the rewrite respectively from “10” and “Y1” to “201” and “Y2”.

Then the node N3 forwards the PBB frame to the output port “Port-3” coupled to the next node N7 on the basis of the value of the output port of the second entry.

Upon receipt of the PBB frame from the node N3, the node N7 retrieves a corresponding entry from the table of FIG. 14, using the B-VID “201” and the B-DA “Y2” set in the received PBB frame as retrieval keys.

As the result of retrieval, the node N7 detects the second entry in which the available flag is set to be “Available”, and further judges, on the basis of the rewrite field of the second entry, whether or not rewriting of the B-VID and the B-DA is available. In the example of FIG. 14, the rewrite field of the second entry is “NA (Not Available)” and therefore the node N7 does not rewrite the B-VID and the B-DA of the PBB frame received from the node N3.

Then the node N7 forwards the PBB frame to the output port “Port-3” coupled to the next node N4 on the basis of the value of the output port of the second entry.

Upon receipt of the PBB frame from the node N7, the node N4 rewrites, for example, the B-VID and the B-DA of the received PBB frame respectively from “201” and “Y2” to “10” and “Y1” on the basis of the table contents possessed by the FDB 5, and forwards the PBB frame to the EBEB 9-2 (node N5).

Upon receipt of the PBB frame from the node N4, the node N5 detects that the B-DA of the received PBB frame is set to be the MAC address “Y1” of the node (N5) itself and performs the terminal processing on the PBB frame. At that time, the node N5 decapsulates the PBB frame by removing the B-TAG, the B-DA, the B-SA, and I-TAG from the PBB frame and thereby extract (creates) the user frame, which then the node N5 forwards to the another network (such as a PBN, a PBBN, and others).

As the above example, even when failures occur on a number of segments, a number of protection paths that detour individual failure segments can be prepared. In addition, different values (“200” and “201” in the example of FIG. 13) can be provided to the B-VIDs of the respective protection paths, so that the scalability of the network 10 is improved.

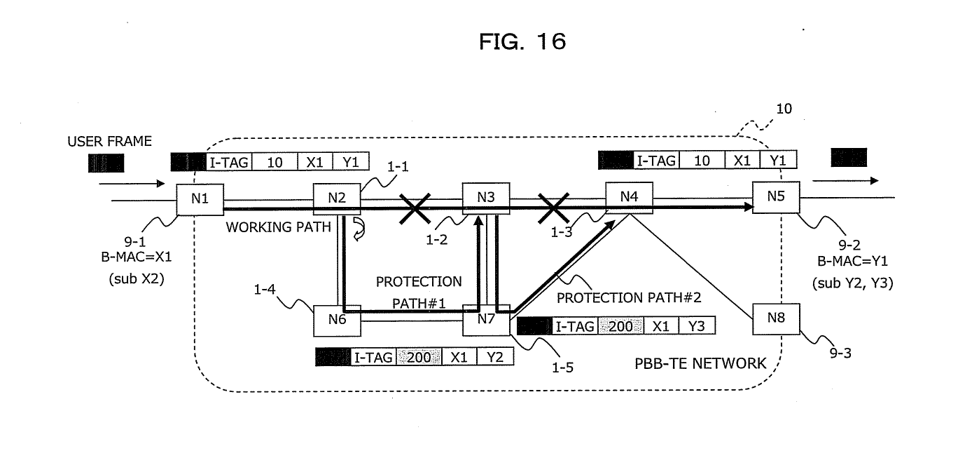

In addition, as illustrated in FIG. 16, a number of sub-addresses “Y2” and “Y3” may be set for the EBEB 9-2 (node N5) and a number of protection paths (Protection Path #1, Protection Path #2) on the basis of the sub-addresses.

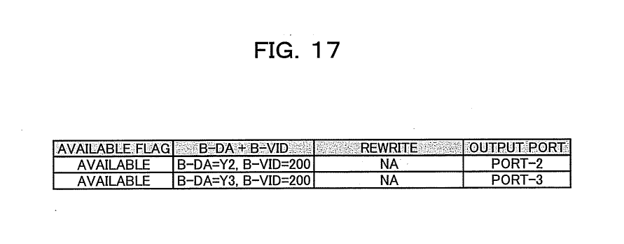

In this case, the node N7 possesses the table illustrated in FIG. 17, for example.

This table exemplarily includes a first entry in which the available flag “Available”, the B-DA+B-VID “B-DA=Y2, B-VID=200”, the rewrite “NA”, and the output port “Port-2” are associated with one another, and a second entry in which the available flag “Available”, the B-DA+B-VID “B-DA=Y3, B-VID=200”, the rewrite “NA”, and the output port “Port-3” are associated with one another. The Port-2 is an output port of the node N7 that is coupled to the route from the node N7 to the node N3, and the Port-3 is another output port of the node N7 that is coupled to the route from the node N7 to the node N4 in FIG. 16. The B-DA of Protection Path #1 is set to be a different value from that of Protection Path #2 so that the FDB 5 of the node N7 can recognize Protection Path #1 and Protection Path #2 to be different from each other.

In carrying out forwarding processing of a PBB frame on the basis of the table of in FIG. 17, the node N7 firstly causes the frame receiving unit 2 to receive the PBB frame from the node N6.

Next, the node N7 retrieves a corresponding entry from the table of FIG. 17, using the B-VID “200” and the B-DA “Y2” set in the received PBB frame as retrieval keys.

As the result of retrieval, the node N7 detects the first entry in which the available flag is set to be “Available”, and further judges, on the basis of the rewrite field of the first entry, whether or not rewriting of the B-VID and the B-DA is available. In the example of FIG. 17, the rewrite field of the first entry is “NA (Not Available)” and therefore the node N7 does not rewrite the B-VID and the B-DA of the PBB frame received from the node N6.

Then the node N7 forwards the PBB frame to the output port “Port-2” coupled to the next node N3 on the basis of the value of the output port in the first entry.

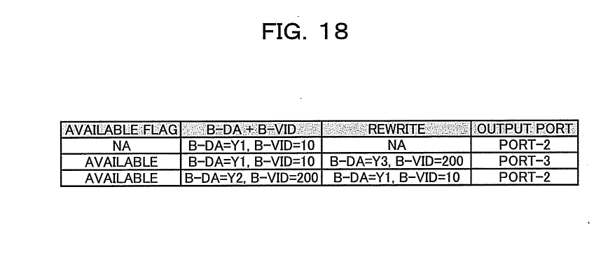

The node N3, which is the end node of Protection Path#1 and is the start node of Protection Path #2, possesses the table denoted in FIG. 18 when, for example, a failure is occurring on the route between the nodes N3 and N4.

The table of FIG. 18 exemplarily includes a first entry in which the available flag “NA”, the B-DA+B-VID “B-DA=Y1, B-VID=10”, the rewrite “NA”, and the output port “Port-2” are associated with one another, a second entry in which the available flag “Available”, the B-DA+B-VID “B-DA=Y1, B-VID=10”, the rewrite “B-DA=Y3, B-VID=200”, and the output port “Port-3” are associated with one another, and a third entry in which the available flag “Available”, the B-DA+B-VID “B-DA=Y2, B-VID=200”, the rewrite “B-DA=Y1, B-VID=10”, and the output port “Port-2” are associated with one another. The Port-2 is an output port of the node N3 that is coupled to the route (working path) from the node N3 to the node N4, and the Port-3 is another output port of the node N3 that is coupled to the route (protection path) from the node N3 to the node N7 in the configuration of FIG. 16.

While no failure is occurring on the route between the nodes N3 and N4, the Node N3 changes the available flag of the first entry of the table in FIG. 18 from “NA” to “Available” and changes that of the second entry from “Available” to “NA” so that the node N3 directly forwards the PBB frame received from the node N2 or N7 to the node N4.

As illustrated in the example FIG. 16, while a failure is occurring on the route between the nodes N3 and N4, the node N3 receives the PBB frame in which the B-VID and the B-DA are respectively set to be “200” and the “Y2” from the node N7 through Protection Path #1.

Next, the node N3 retrieves a corresponding entry from the table of FIG. 18, using the B-VID “200” and the B-DA “Y2” set in the received frame as retrieval keys.

As the result of retrieval, the node N3 detects the third entry in which the available flag is set to be “Available”, and further judges, on the basis of the rewrite field of the third entry, whether or not rewriting of the B-VID and the B-DA is available. In the example of FIG. 18, the rewrite field of the third entry is available to be “B-DA=Y1, B-VID=10” and therefore the node N3 rewrites the B-VID and the B-DA of the PBB frame received from the node N7 respectively from “200” and “Y2” to “10” and “Y1”.

Then the node N3 attempts to forward the PBB frame to the output port “Port-2” coupled to the next node N4 on the basis of the value of the output port of the third entry. However, since Port-2 (the link to the node N4) is down, the PBB frame is not sent to the Port-2.

In this case, the node N3 again retrieves a corresponding entry from the table of FIG. 18, using the B-VID “10” and the B-DA “Y1” after the rewrite as the retrieval keys.

As the result of the second retrieval, the node N3 detects the second entry in which the available flag is set to be “Available”, and further judges, on the basis of the rewrite field of the second entry, whether or not rewriting of the B-VID and the B-DA is available. In the example of FIG. 18, the rewrite field of the second entry is available to be “B-DA=Y3, B-VID=200” and therefore the node N3 rewrites the B-VID and the B-DA of the PBB after the rewrite respectively from “10” and “Y1” to “200” and “Y3”.

Then the node N3 forwards the PBB frame to the output port “Port-3” coupled to the next node N7 on the basis of the value of the output port of the second entry.

Upon receipt of the PBB frame from the node N3, the node N7 retrieves a corresponding entry from the table of FIG. 17, using the B-VID “200” and the B-DA “Y3” set in the received PBB frame as retrieval keys.

As the result of retrieval, the node N7 detects the second entry in which the available flag is set to be “Available”, and further judges, on the basis of the rewrite field of the second entry, whether or not rewriting of the B-VID and the B-DA is available. In the example of FIG. 17, the rewrite field of the second entry is “NA (Not Available)” and therefore the node N7 does not rewrite the B-VID and the B-DA of the PBB frame received from the node N3.

Then the node N7 forwards the same PBB frame to the output port “Port-3” coupled to the next node N4 on the basis of the value of the output port of the second entry.

Upon receipt of the PBB frame from the node N7, the node N4 rewrites, for example, the B-VID and the B-DA of the received PBB frame respectively from “200” and “Y3” to “10” and “Y1” on the basis of the table contents possessed by the FDB 5, and forwards the PBB frame to the EBEB 9-2 (node N5).

Upon receipt of the PBB frame from the node N4, the node N5 detects that the B-DA of the received PBB frame is set to be the MAC address “Y1” of the node (N5) itself and performs the terminal processing on the PBB frame. At that time, the node N5 decapsulates the PBB frame by removing the B-TAG, the B-DA, the B-SA, and I-TAG from the PBB frame and thereby extracts (creates) the user frame, which then the node N5 forwards to the another network (such as a PBN, a PBBN, and others).

Setting a number of sub-addresses for the EBEB 9-2 (node N5) and allocating the different sub-addresses to respective protection paths can discriminate the protection paths from one another, ensuring the same advantages as the above. Alternatively, allocation of different B-VIDs and different B-DAs to respective protection paths further improves the scalability of the network.

(2) First Modification:

Alternatively, a sub-address may be created (set) through varying (inverting) part of the 48-bit MAC address (main address) of the EBEB 9-2 (node N5) in accordance with the operation status (working path or protection path) of the PBB-TE network 10. Specifically, in this modification, part of the 48-bit MAC address is used as an identification bit flag between the Working Path and the Protection Path, so that the address space of the working path/protection path can be expanded. The network 10 of the first modification has the same configuration as that of FIG. 6.

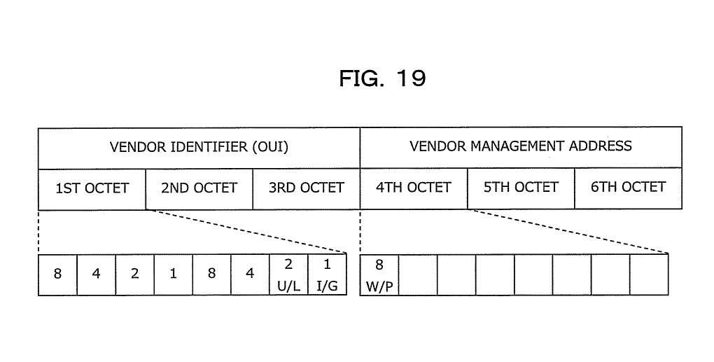

FIG. 19 illustrates an example of the structure of a MAC address.

As illustrated in FIG. 19, the MAC address is formed of 48 bits (six octets), in which the first-half three octets function as a vendor identifier (Organizationally Unique Identifier, OUI) and the latter-half three octets function as a vendor management address.

The I/G (Individual/Group) bit at the LSB of the first octet being “0” represents that the corresponding MAC address is a unicast address while the I/G bit being “1” represents that the corresponding MAC address is a multicast address. The second bit of the first octet is a U/L (Universal/Local) bit, and the U/L bit being “0” represents that the corresponding MAC address is a global address while the U/L bit being “1” represents the corresponding MAC address is local address.

This modification uses, for example, the eighth bit (LSB) of the fourth octet as the W/P (Working/Protection) bit. When a PBB frame is transmitted through the working path, the W/P bit of the B-DA is set to be “0” while when a PBB frame is transmitted through a protection path, the W/P bit of the B-DA is set to be “1”.

Thereby, when the W/P bit of is the MAC address of the EBEB 9-2 set in the B-DA of the PBB frame is “0”, each node 1 (9) transmits the PBB frame through the working path. Conversely, when the W/P bit is “1”, the node 1 (9) transmits the PBB frame through the protection path.

Namely, this modification sets a MAC address having a W/P bit of “0” as the main address of the EBEB 9-2 and sets a MAC address having a W/P bit of “1” as the sub-address of the EBEB 9-2.

(2.1) Example of Operation of the Node 1:

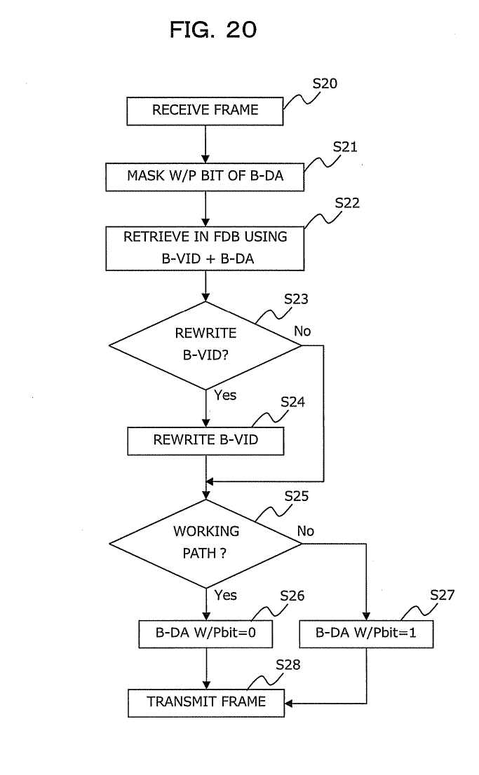

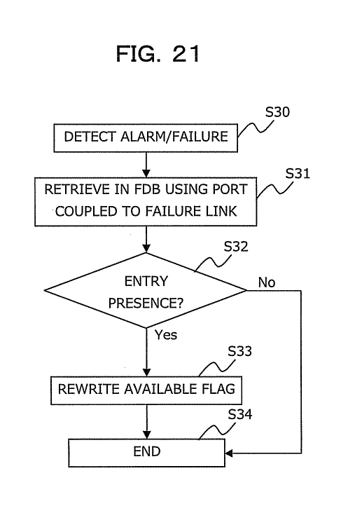

Here, description will now be made in relation to an example of the operation of the node 1 with reference to FIGS. 20 and 21.

As illustrated in FIG. 20, the frame receiving unit 2 of the node 1 receives a PBB frame from another node (step S20).

Then the node 1 masks the W/P bit value of the MAC address set in the B-DA of the received PBB frame (step S21).

The bridging unit 3 of the node 1 retrieves an entry from the table stored in the FDB 5, using the B-VID and the B-DA set in the received PBB frame as retrieval keys (step S22). The retrieval may be carried out so as to exclude the entry having an available flag of “NA” from the result.

The bridging unit 3 of the node 1 judges whether or not the B-VID rewrite set in the entry obtained as the result of the retrieval is available (step S23). If the rewrite is available (YES route in step S23), the bridging unit 3 transmits the received PBB frame to the B-VID converting unit 7, which then rewrites the B-VID of the PBB frame (step S24). On the other hand, if the B-VID rewrite of the obtained entry is not available (No route in step S23), the B-VID is not rewritten.

Then the node 1 judges whether the value of the W/P field of the obtained entry is “W (Working Path)” or “P (Protection Path)” (step S25). The W/P field indicates that the received PBB frame is to be sent (forwarded) to the working path or the protection path. For example, when the PBB frame is sent to the working path, the value of the W/P field is set to be “W (0)” while when the PBB frame is sent to the protection path, the value of the W/P field is set to be “P (1)”.

If judging the value of the W/P field of the obtained entry to be “W” (Yes route in step S25), the node 1 sets the W/P bit of the MAC address set in the B-DA of the PBB frame to be “0” (step S26) and sends the PBB frame to the next node (step S28).

In the meantime, if judging the value of the W/P field of the obtained entry to be “P” (No route in step S25), the node 1 sents the W/P bit of the MAC address set in the B-DA of the PBB frame to be “1” (step S27) and sets the PBB frame to the next node (step S28).

Referring to FIG. 21, when the alarming/failure-sensing section 6 detects a failure (or an alarm) (step S30), the alarming/failure-sensing section 6 retrieves an entry from the table stored in the FDB 5, using the output port coupled to the link (route) on which the failure is occurring (step S31). The retrieval may be carried out so as to exclude an entry having an available flag of “NA” from the result.

The alarming/failure-sensing section 6 judges the presence or the absence of an entry obtained by the retrieval (step S32), and if judging the absence of the corresponding entry (No route in step S32), finishes the procedure (step S34).

On the contrary, if judging the presence of the corresponding entry (Yes route in step S32), the alarming/failure-sensing section 6 rewrites the available flag of the obtained entry (step S33) and finishes the procedure (step S34). For example, when the retrieval at step S32 detects an entry having an available flag set to be “Available”, the alarming/failure-sensing section 6 changes the available flag of the obtained entry to “NA” while when the retrieval at step S32 detects an entry having an available flag set to be “NA”, the alarming/failure-sensing section 6 changes the available flag of the obtained entry to “Available”.

(2.2) Example of Network (PBB-TE Network) 10:

Next, description will now be made in relation to an example of operation of the PBB-TE network 10 including the above node 1.

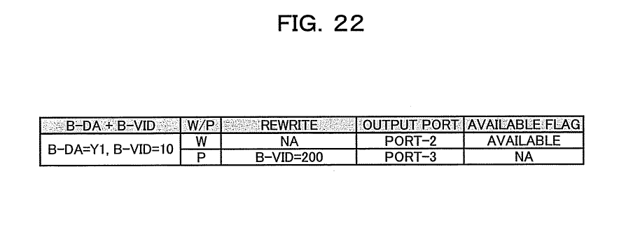

FIG. 22 is an example of the table stored in the node N2 while the PBB-TE network 10 operates normally.

This table exemplarily includes a first entry in which the B-DA+B-VID “B-DA=Y1, B-VID=10”, the W/P “W”, the rewrite “NA”, the output port “Port-2”, and the available flag “Available” are associated with one another, and a second entry in which the B-DA+B-VID “B-DA=Y1, B-VID=10”, the W/P “P”, the rewrite B-VID=200”, the output port “Port-3”, and the available flag “NA” are associated with one another.

In cases where the node N2 carries out forwarding processing of a PBB frame on the basis of the table of FIG. 22, the node N2 causes the frame receiving unit 2 to receive a PBB frame from the node N1. In the PBB frame, “I-SID”, the MAC address “X1” of the node (N1) itself, the MAC address (main address) “Y1” of the EBEB 9-2 (N5) associated with the working path, and “10” are set, by the node 1, as the user identifier, the B-SA, the B-DA, and the B-VID, respectively.

Then the node N2 retrieves a corresponding entry from the table of FIG. 22, using the B-VID “10” and the B-DA “Y1” set in the received PBB frame as retrieval keys.

As the result of the retrieval, the node N2 detects the first entry having an available flag set to be “Available”, and judges, on the basis of the write field of the first entry, whether or not the rewrite of the B-VID and the B-DA is available. In the example of FIG. 22, since the rewrite field of the B-VID and the B-DA of the first entry is “NA (Not Available)”, the node N2 does not rewrite the B-VID and the B-DA of the PBB frame received from the node N1.

In the example of FIG. 22, the W/P field of the first entry is “W”, which causes the node N2 to set the value of the W/P bit of the B-DA of the PBB frame to be “0”. When the value of the W/P bit of the B-DA of the received PBB frame corresponds to the value of the W/P filed of the detected entry, the above setting procedure may be omitted.

Then the node N2 forwards the PBB frame to the output port “Port-2” coupled to the next node N3 on the basis of the value of the output port of the first entry.

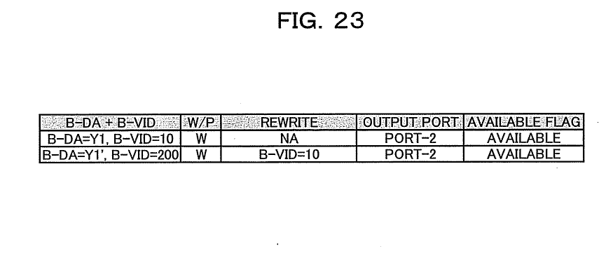

FIG. 23 is an example of the table possessed by the node N3.

This table exemplarily includes a first entry in which the B-DA+B-VID “B-DA=Y1, B-VID=10”, the W/P “W”, the rewrite “NA”, the output port “Port-2”, and the available flag “Available” are associated with one another, and a second entry in which the B-DA+B-VID “B-DA=Y1′, B-VID=200”, the W/P “W”, the rewrite B-VID=10”, the output port “Port-2”, and the available flag “Available” are associated with one another. The B-DA “Y1′” is a sub-address of the EBEB 9-2 (N5) in which the W/P bit of the B-DA “Y1” is changed from “0” to “1”.

Upon receipt of the PBB frame from the node N2, the node N3 retrieves a corresponding entry from the table of FIG. 23, using the B-VID “10” and the B-DA “Y1” set in the received PBB frame as retrieval keys.

As the result of the retrieval, the node N3 detects the first entry having an available flag set to be “Available”, and further judges, on the basis of the rewrite field of the first entry, whether or not rewrite of the B-VID is available. In the example of FIG. 23, since the rewrite field of B-VID of the first entry is set to be “NA (Not Available)”, the node N3 does not rewrite the B-VID of the PBB frame received from the node N2.

In the example of FIG. 23, since the W/P field of the first entry is “W”, the node N3 sets the value of the W/P bit of the B-DA of the PBB frame to be “0”. When the value of the W/P bit of the B-DA of the received PBB frame corresponds to the value of the W/P filed of the detected entry, the above setting procedure may be omitted.

Then the node N3 forwards the PBB frame to the output port “Port-2” coupled to the next node N4 on the basis of the value of the output port of the first entry.

The node N4 carries out the same forwarding processing as performed in the node N3 and consequently forwards the PBB frame to the node N5.

Upon receipt of the PBB frame from the node N4, the node N5 detects that the MAC address (main address) “Y1” of the node (N5) itself is set in the B-DA of the received PBB frame, and decapsulates the PBB frame to extract the user frame, which then the node N5 forwards to another network.

Assuming that the alarming/failure-sensing section 6 detects a failure (or an alarm) occurring on the route coupled to the node N3, the node N2 retrieves a corresponding entry from the table of FIG. 22, using the output port “Port-2” coupled to the link (route) on which the failure is occurring as a retrieval key.

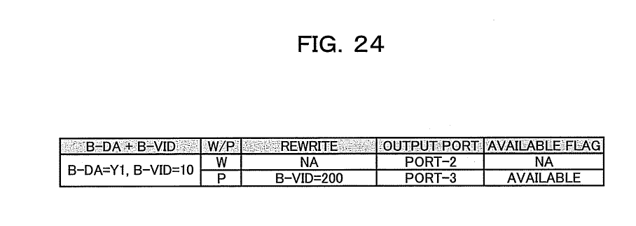

As a result of the retrieval, the node N2 detects the first entry and, as illustrated in FIG. 24, changes the available flag of the first entry to “NA” and also changes that of the second entry to “Available”.

After that, the node N2 carries out the forwarding processing of the PBB frame on the basis of the table (after the changing) of FIG. 24.

For example, upon receipt of the PBB frame from the node N1, the node N2 retrieves a corresponding entry from the table of FIG. 24, using the B-VID “10” and the B-DA “Y1” set in the PBB frame as retrieval keys.

As the result of the retrieval, the node N2 detects the second entry having an available flag set to be “Available”, and further judges, on the basis of the rewrite field of the second entry, whether or not rewrite of the B-VID is available. In the example of FIG. 24, since the rewrite field of B-VID of the first entry is set to be available to be “B-VID=200”, the node N2 rewrites the B-VID of the PBB frame received from the node N1 from “10” to “200”.

In the example of FIG. 24, since the W/P field of the second entry is “P”, the node N2 changes (sets) the value of the W/P bit of the B-DA of the PBB frame from “0” to“1”.

Then the node N2 forwards the PBB frame to the output port “Port-3” coupled to the next node N6 on the basis of the value of the output port of the second entry.

As the above, in the event of sensing a failure, the node N2 can forward the PBB frame, switching the forwarding route from the working path to the protection path. As substitute for changing the B-VID and the W/P bit, changing only the W/P bit can attain the same results.

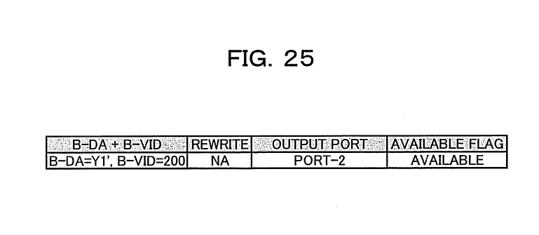

FIG. 25 is an example of a table possessed by the node N6.

This table exemplarily includes a first entry in which the B-DA+B-VID “B-DA=Y1′, B-VID=200”, the rewrite “NA”, the output port “Port-2”, and the available flag “Available” are associated with one another.

Upon receipt of the PBB frame from the node N2, the node N6 retrieves a corresponding entry from the table of FIG. 25, using the B-VID “200” and the B-DA Y1′” set in the PBB frame as retrieval keys.

As the result of the retrieval, the node N6 detects the first entry having an available flag set to be “Available”, and further judges, on the basis of the rewrite field of the first entry, whether or not rewrite of the B-VID is available. In the example of FIG. 25, since the rewrite field of B-VID of the first entry is set to be “NA (Not Available)”, the node N6 does not rewrite the B-VID of the PBB frame received from the node N2.

Then the node N6 forwards the PBB frame to the output port “Port 2” coupled to the next node N7 on the basis of the value of the output port of the first entry.

The node N7 carries out the same forwarding processing as performed in the node N6 and consequently forwards the PBB frame to the node N3.

Upon receipt of the PBB frame from the node N7, the node N3 retrieves a corresponding entry from the table of FIG. 23, using the B-VID “200” and the B-DA “Y1′” set in the received PBB frame as retrieval keys.

As the result of the retrieval, the node N3 detects the second entry having an available flag set to be “Available”, and further judges, on the basis of the rewrite field of the second entry, whether or not rewrite of the B-VID is available. In the example of FIG. 23, since the rewrite field of B-VID of the second entry is set to be “Available” to be “B-VID=10”, the node N3 rewrites the B-VID of the PBB frame received from the node N7 from “200” to “10”.

In the example of FIG. 23, since the W/P field of the second entry is “W”, the node N3 changes (sets) the value of the W/P bit of the B-DA of the PBB frame to be “0”.

Then the node N3 forwards the PBB frame to the output port “Port-2” coupled to the next node N4 on the basis of the value of the output port of the second entry.

The node N4 carries out the same forwarding processing as performed in the node N3 and consequently forwards the PBB frame to the node N5.

Upon receipt of the PBB frame from the node N4, the node N5 detects that the MAC address (main address) “Y1” of the node (N5) itself is set in the B-DA of the received PBB frame, and decapsulates the PBB frame to extract the user frame, which then the node N5 forwards to another network.

The first modification detailed above in which the EBEB 9-2 (N5) is created by changing the W/P bit of the main address thereof attains the same effects as those of the first embodiment. In addition, control over the W/P bit can control the switch between the working path and the protection path, so that the control (over the network) can be simplified. Furthermore, the amount of data to be stored in the FDB 5 can be reduced so that the memory usage can be reduced.

(3) Second Modification;

Alternatively, the B-DA of the PBB frame may be set to be the MAC address of the node (N3) that terminates the protection path.

In this case, when the node N2 detects occurrence of a failure on the route between the nodes N2 and N3, the node N2 changes the value of the B-DA of the PBB frame received from the node N1 from “Y1” to “Z (the MAC address of the node N3).

On the basis of the contents of the table possessed by the node N2, the node N2 forwards the PBB frame to the node N3 through the protection path. Upon receipt of the PBB frame from the node N2 through the protection path, the node N3 may change the value of the B-DA of the received PBB frame from “Z” to “Y1” and then forward the PBB frame to the next node N4.

The second modification ensures the same effects as those of the first embodiment, and can recognize the transmission route of the PBB frame through the use of the MAC address of the relaying apparatus serving as the terminal node of the protection path, so that the MAC address space can be used more efficiently.

(4) Others:

The configuration and each procedural step of the node 1 may be selected, rejected and combined in accordance with requirements.

The above embodiment and modifications assume a network system that adopts a segment protection scheme. Alternatively, the present invention may be applied to a network system that adopts the path protection scheme and other methods of controlling transmission.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment has been described in detail, it should be understood that the various changes, substitutions, and alterations could be made hereto without departing from the spirit and scope of the invention.

What is claimed is:

1. A transmission apparatus which transmits a frame through a working path and a protection path, comprising:
a detecting unit which detects a failure occurring on the working path;
a controller which, when the detecting unit detects the failure, changes a first destination address in the frame to a second destination address different from the first destination address and transmits the frame to the protection path.

2. The transmission apparatus according to claim 1, wherein the first destination address and the second destination address are MAC addresses of a transmission apparatus disposed at the end of the working path.

3. The transmission apparatus according to claim 1, wherein:
the first destination address is a MAC address of a transmission apparatus disposed at the end of the working path; and
the second destination address is one obtained by inverting one or more predetermined bit flags of the first destination address.

4. The transmission apparatus according to claim 1, wherein the second destination address is a MAC address of a transmission apparatus which terminates the protection path.

5. The transmission apparatus according to claim 1, wherein the controller restores the second destination address in the frame after the change to the first destination address and sends the frame to the working path.

6. The transmission apparatus according to claim 1, wherein the controller changes a first route identifier in the frame to a second route identifier different from the first route identifier.

7. The transmission apparatus according to claim 1, wherein, while the detecting unit detects no failure, the controller transmits the frame to the working path on the basis of the first destination address in the frame without performing the changing.

8. A method for transmitting a frame through a working path and a protection path, comprising:
detecting a failure occurring on the working path;
changing a first destination address in the frame to a second destination address in accordance with the result of the detecting; and
transmitting the frame after the changing to the protection path.

9. The method according to claim 8, wherein the first destination address and the second destination address are MAC addresses of a transmission apparatus disposed at the end of the working path.

10. The method according to claim 8, wherein:
the first destination address is a MAC address of a transmission apparatus disposed at the end of the working path; and
the second destination address is one obtained by inverting one or more predetermined bit flags of the first destination address.

11. The method according to claim 8, wherein the second destination address is a MAC address of a transmission apparatus which terminates the protection path.

12. A transmission system comprising a transmission apparatus which transmits a frame through a working path and a protection path, the system comprising:
a detecting unit which detects a failure occurring on the working path;
a controller which, when the detecting unit detects the failure, changes a first destination address in the frame to a second destination address different from the first destination address and transmits the frame to the protection path.
